(19) United States
(12) Patent Application Publication
(10) Pub. No.: US 2023/0140277 A1
(43) Pub. Date: May 4, 2023

(54) BICYCLE BRAKING DEVICE

(71) Applicant: Wayne-Ian MOORE, Changhua City (TW)

(72) Inventor: Wayne-Ian MOORE, Changhua City (TW)

(21) Appl. No.: 17/971,634

(22) Filed: Oct. 23, 2022

(30) Foreign Application Priority Data
Nov. 3, 2021 (TW) 110140967

(51) Int. Cl. B62L 1/00; F16D 65/18

(52) U.S. Cl. CPC B62L 1/005; F16D 65/18; F16D 2121/14

(57) ABSTRACT

A bicycle braking device includes a caliper, two operation units and two links. Each operation unit is installed to the two respectively threaded holes of the caliper and includes an operation assembly and a ring. Two links are respectively connected to the two operation assemblies. Each operation assembly includes multiple curve slots, and multiple balls are partially rotatably accommodated in each curve slot. Each ring is movably mounted to the core part of each operation assembly and includes multiple spiral grooves. The balls are accommodated in the spiral grooves and the curve slots. When the two links are pivoted by pulling the brake cable, the two core parts are rotated, and the two rings rotatably move to push the linings to clamp the brake disk. The balls ensure the rings to move smoothly so as to precisely clamp the brake disk.

### BACKGROUND OF THE INVENTION

### 1. Fields of the Invention

The present invention relates to a bicycle braking device, and more particularly, to a bicycle braking device that reinforces the clamping force to the brake disk and enhances braking stability.

### 2. Descriptions of Related Art

The conventional mechanical bicycle braking device known to applicant is disclosed in Taiwanese Patent Publication No. 201928226, which is connected with a brake cable, and includes a cylinder, a piston, a plurality of beads, two linings control components. The rotation of each lining control component drives the operation part to move axially in the assembly hole of each threaded ring. Each operation part is spirally movable by cooperation with the beads and positioning holes to further move the linings to clamp the brake disk. The beads reinforce the clamping force of the linings.

However, the above-mentioned braking system has a disadvantage, which lies in that the position and direction of each groove for accommodating the beads in the operation part is a spiral arrangement from top to bottom, and due to the pivoting direction of the shaft, such that as long as the instantaneous pivoting force of the axis is large, the beads may jump out and enter into the adjacent groove. Therefore, the operation part cannot move precisely to produce the best clamping force. In addition, please refer to Korean Patent 10-0999381 for “Disk Brake Parking Brake Device”, mainly to focus on reducing manufacture cost of the brake disk and parking brake device. The finger part and the pad are in close contact with two sides of the magnetic disk. The brake caliper includes a cylinder whose piston moves the pad toward the brake disk hydraulically or mechanically.

In the parking brake device of the disk brake, there is a cam device for converting the linear motion to the rear end of the cylinder. The cam device includes a slider and a cam shaft. The slider has a hollow area formed between the slider and the circumferential surface so as to accommodate one or more guide shafts. There is at least one guide groove formed in the outer circumferential surface of the cam shaft. The guide shaft is engaged with the guide groove.

The slider includes the grooves that are defined through the slider, however, the grooves weaken the structural strength of the slider.

The present invention intends to provide a bicycle braking device to eliminate the shortcomings mentioned above.

### SUMMARY OF THE INVENTION

The present invention relates to a bicycle braking device and comprises a caliper having a gap formed between two side parts thereof. Each of the two side parts includes a threaded hole which communicates with the gap. Two operation units are respectively installed to the two threaded holes, and each operation unit includes an operation assembly and a ring. Each operation assembly has a protrusion protruding beyond the threaded hole and the outside of the caliper corresponding thereto. Each of the operation assemblies includes multiple curve slots which are located in the threaded hole corresponding thereto. The curve slots are spaced from each other and each curve slot have multiple balls partially and rotatably accommodated therein.

Two links each have the first end thereof connected to the protrusion of the operation assembly corresponding thereto. Each of the rings includes multiple spiral grooves formed to the inner periphery thereof. The spiral grooves are not in communication with each other. The multiple balls are partially accommodated in the spiral grooves. The rings are axially movable relative to the operation assembly.

Two linings are respectively connected to the two side parts of the caliper and located within the gap. When the rings move axially relative to the operation assembly and toward the gap, the two linings move and clamp the brake disk located between the two linings.

The two operation assemblies are rotated when the two links are respectively pivoted about the protrusions of the operation assemblies. The balls are rotated in the curve slots so that the rings are axially moved and protrude into the gap to move the two linings to clamp the brake disk. The two rings are moved into the threaded holes when the two links are pivoted reversely, the two linings remove from the brake disk.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle braking device of the present invention;

FIG. 2 is an exploded view of the bicycle braking device of the present invention;

FIG. 3 shows the core part, the sleeve and the ring;

FIG. 4 is a perspective view to show the ring with the spiral grooves of the bicycle braking device of the present invention;

FIG. 5 is a cross sectional view, taken along line V-V in FIG. 1;

FIG. 6 shows that the bicycle braking device of the present invention and the brake disk;

FIG. 7 is a cross sectional view, taken along line VII-VII in FIG. 7, and

FIG. 8 shows that the two rings move axially to move the two linings to clamp the brake disk.

### DETAILED DESCRIPTION OF THE PREFERRED EMBODIMENT

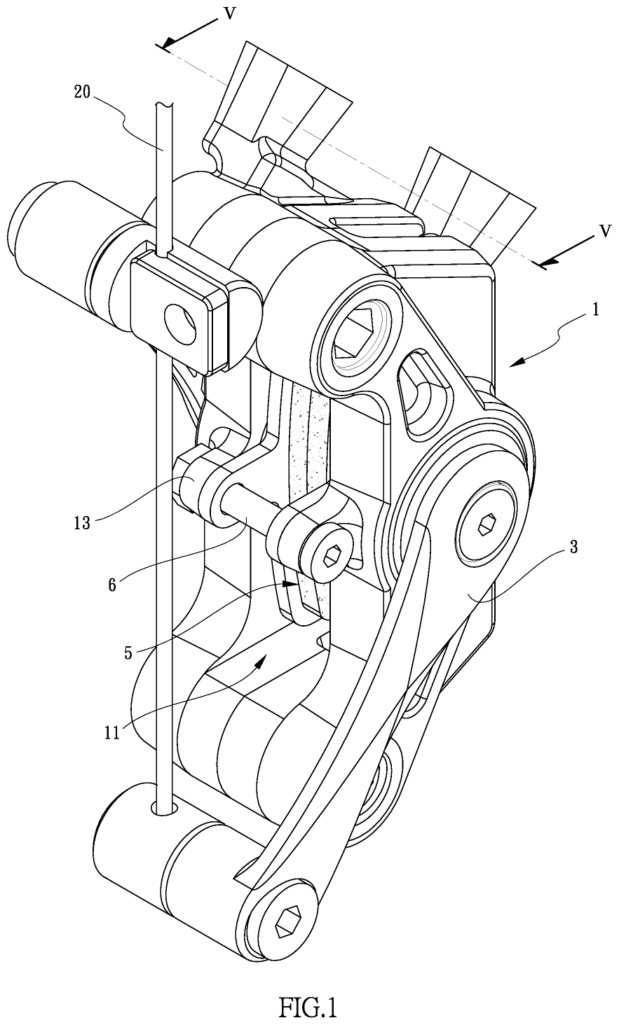

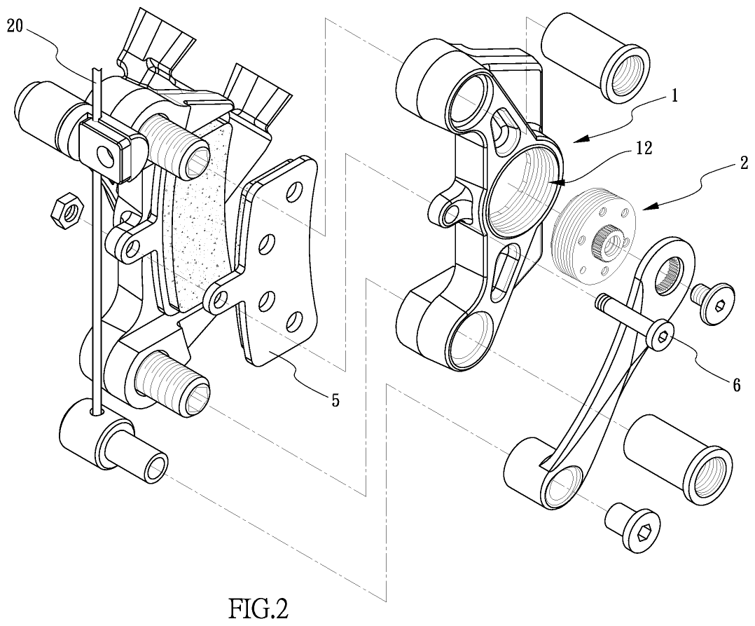

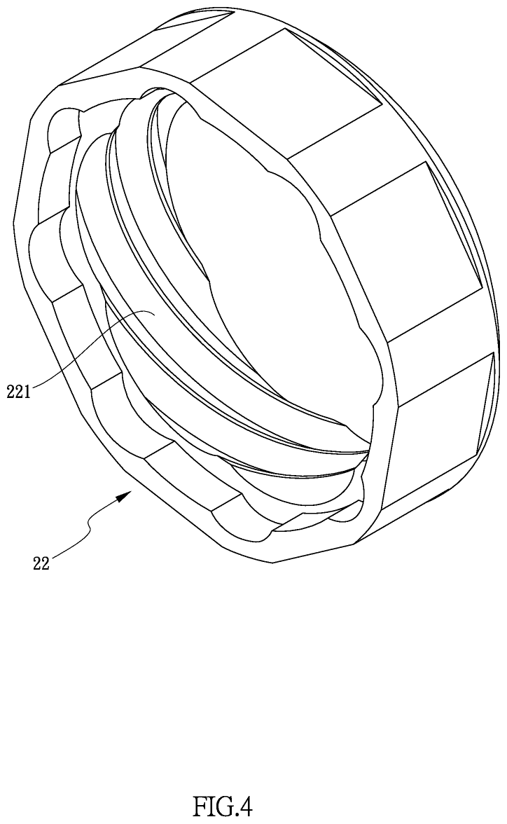

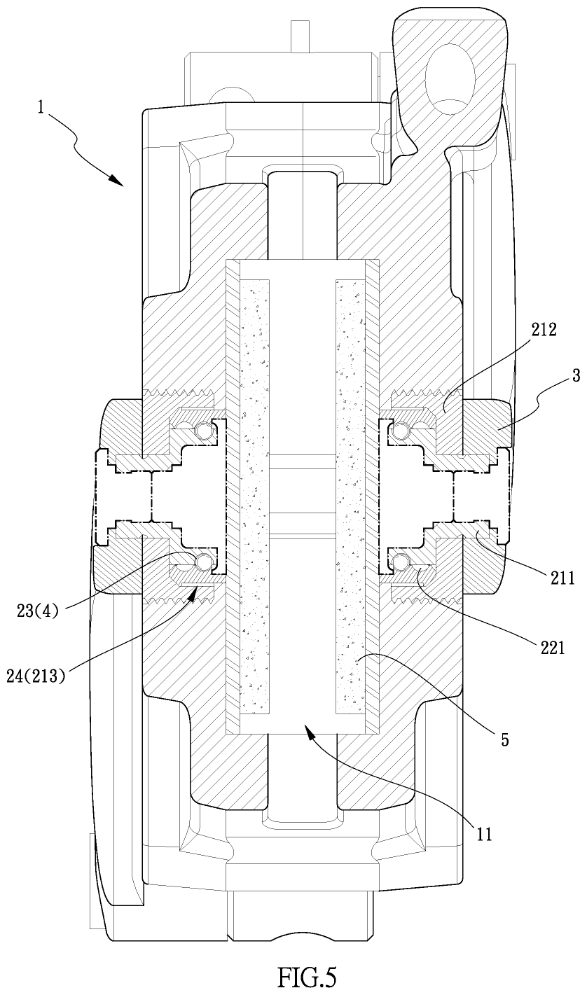

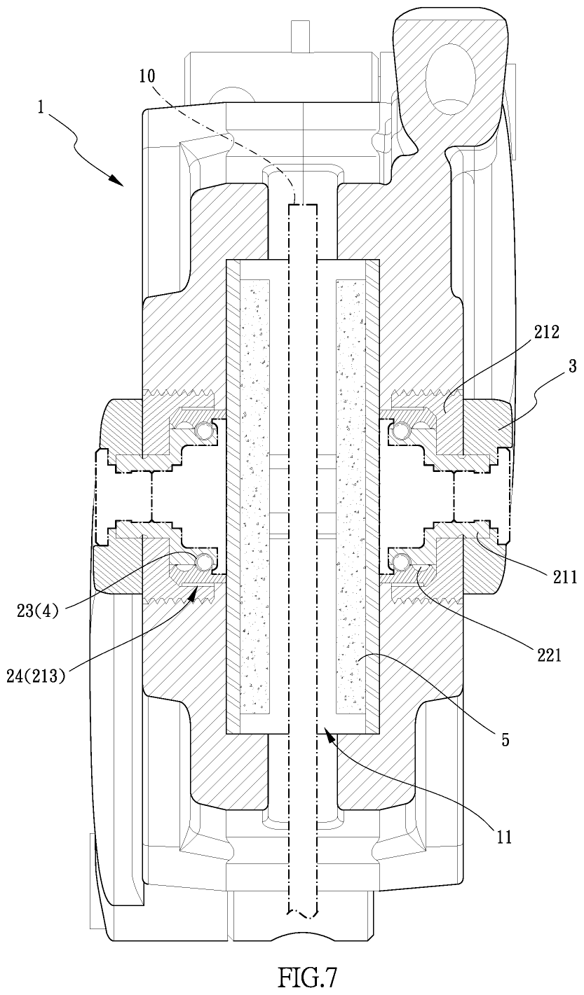

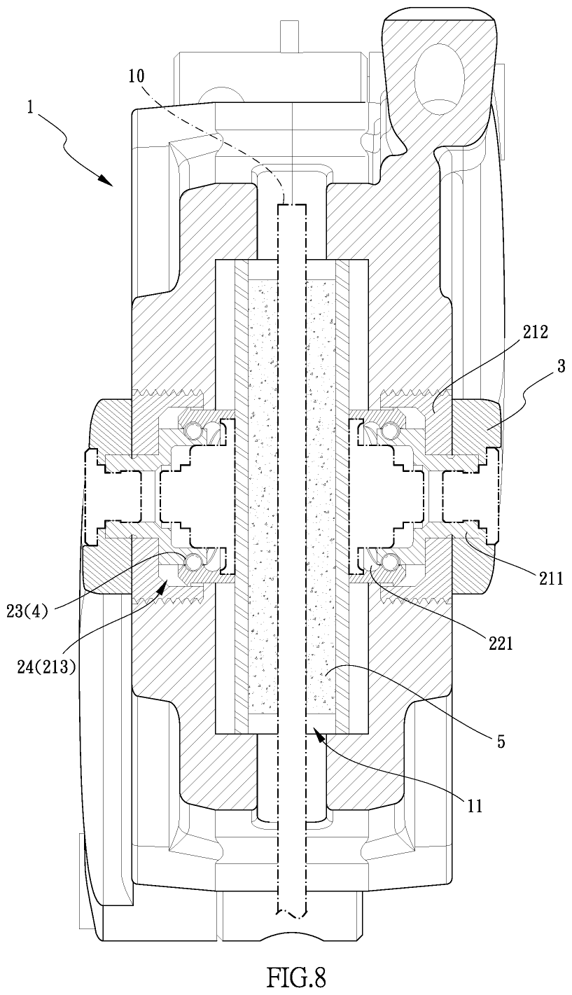

Referring to FIGS. 1 to 8, the bicycle braking device of the present invention comprises a caliper 1 which has a gap 11 formed between two side parts thereof, and each of the two side parts includes a threaded hole 12 which communicates with the gap 11. Two operation units 2 are respectively threaded to the two threaded holes 12. Each operation unit 2 includes an operation assembly 21 and a ring 22. Each operation assembly 21 includes a protrusion protruding beyond the threaded hole 12 and the outside of the caliper 1 corresponding thereto. Each of the operation assemblies 21 includes multiple curve slots 23 which are located within the threaded hole 12 corresponding thereto. The curve slots 23 are spaced from each other and each curve slot 23 has multiple balls 4 partially and rotatably accommodated therein. In this embodiment, three balls 4 are located in each curve slot 23 and do not drop off from the curve slot 23. Two links 3 each have the first end thereof connected to the protrusion of the operation assembly 21 corresponding thereto. Each of the rings 22 includes multiple spiral grooves 221 formed to the inner periphery thereof, wherein the spiral grooves 221 are not in communication with each other. The multiple balls 4 are partially accommodated in the spiral grooves 221. The ring 22 is axially movable relative to the operation assembly 21. Two linings 5 are respectively connected to the two side parts of the caliper 1 and located within the gap 11. When the rings 22 move axially relative to the operation assembly 21 and toward the gap 11, the two linings 5 move and clamp a brake disk 10 located between the two linings 5. The two operation assemblies 21 are rotated when the two links 3 are respectively pivoted about the protrusions of the operation assemblies 21 corresponding thereto. The balls 4 are rotated in the curve slots 23 and the spiral grooves 221 so that the rings 22 are axially moved and protrude into the gap 11 to move the two linings 5 to clamp the brake disk 10. On the contrary, when the two links are pivoted reversely, the two rings 22 are moved into the threaded holes 12, and the two linings 5 remove from the brake disk 10.

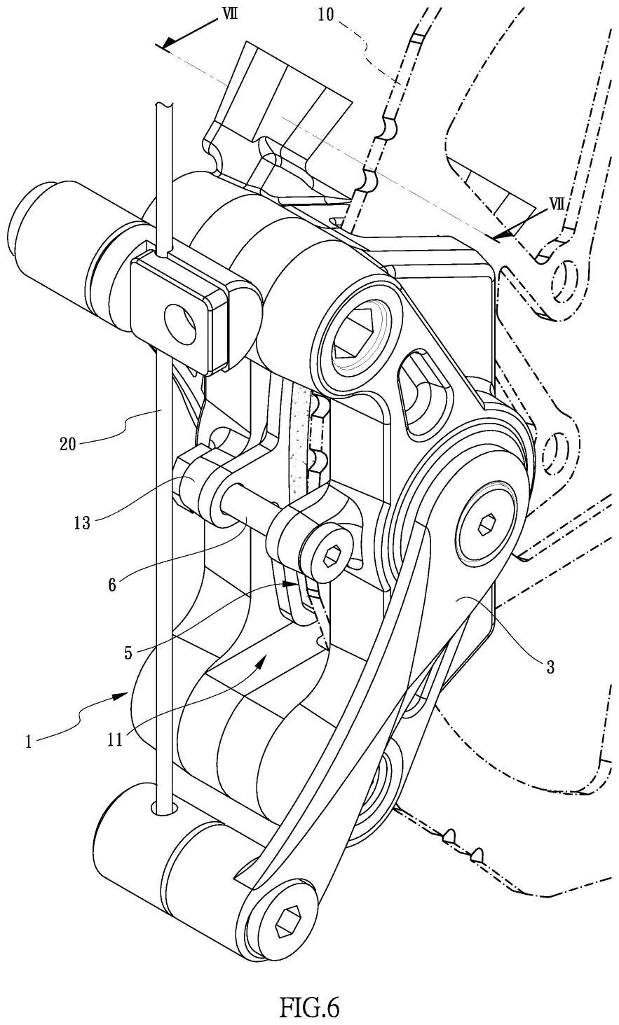

When riding the bicycle along a down-slop road or a rugged road, the rider generally reduces the speed by braking the bicycle. One of the two links 3 has the second end thereof connected to a brake cable 20 which extends toward and is connected to another one of the two links 3 so that the brake cable 20 pivots the two links 3 simultaneously as shown in FIGS. 6 to 8.

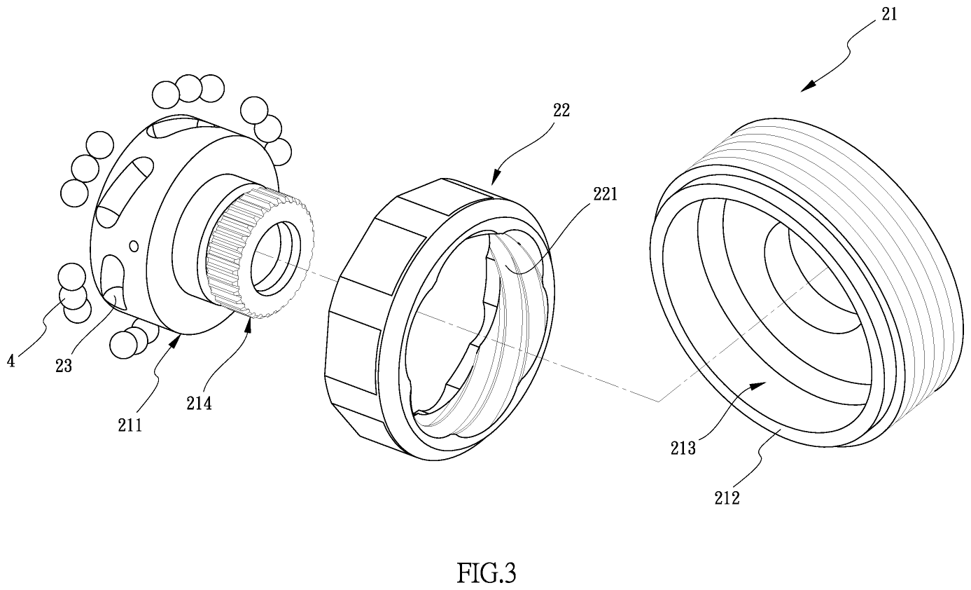

As shown in FIGS. 3 to 7, each of the operation assemblies 21 includes a core part 211 and a sleeve 212 which is threadedly connected to the threaded hole 12 of the link 3 corresponding thereto. Each sleeve 212 has a mount hole 213 defined axially therethrough. Each of the core parts 211 is partially accommodated in the mount hole 213 corresponding thereto. Each core part 211 has the protrusion protruding from one side thereof and the protrusion protrudes beyond the sleeve 212. The protrusion of each core part 211 has a toothed portion 214 formed axially in the outer periphery thereof. The curve slots 23 are formed to the outer periphery of each of the core parts 211. The toothed portion 214 of each core part 211 is engaged with a hole in the first end of the link 3 corresponding thereto, so that when the link 3 is pivoted, the core part 211 is rotated. A room 24 is formed between the inner periphery of the mount hole 213 of the sleeve 212 and the outer periphery of the core part 211 of each operation assembly 21. The ring 22 is movably located in the room 24.

As shown in FIG. 1, the caliper 1 includes two lugs 13 between which the gap 11 is located. A bolt 6 extends through the two lugs 13 and the two linings 5 to position the two linings 5 in the gap 11 so that the two linings 5 are secured to the caliper 1 and located in the gap 11 to as to clamp the brake disk 10.

When the two operation assemblies 21 rotate by pulling the brake levers (not shown), the two links 3 are pivoted simultaneously by pulling the brake cable 20, and the balls 4 rolls in the curve slots 23 of the core part 211 and the spiral grooves 221 of the ring 22, so that the rings 22 are driven by the balls 4 and spirally and axially move into the gap 11 to move the two linings 5 to clamp brake disk 10 to reduce the bicycle speed. On the contrary, when releasing the brake levers (not shown), the two links 3 are pivoted reversely, the two rings 22 are moved into the threaded holes 12, and the two linings 5 remove from the brake disk 10. The linings 5 of the present invention are moved by the rings 22 and therefore firmly clamp the brake disk 10. In addition, the balls 4 in the curve slots 23 and the spiral grooves 221 make the movement of the rings 22 smoothly to precisely clamp the brake disk 10.

While we have shown and described the embodiment in accordance with the present invention, it should be clear to those skilled in the art that further embodiments may be made without departing from the scope of the present invention.

What is claimed is:

1. A bicycle braking device comprising:
a caliper having a gap formed between two side parts thereof, each of the two side parts including a threaded hole which communicates with the gap;
two operation units respectively installed to the two threaded holes, each operation unit including an operation assembly and a ring, each operation assembly having a protrusion protruding beyond the threaded hole and an outside of the caliper corresponding thereto, each of the operation assemblies including multiple curve slots which are located in the threaded hole corresponding thereto, the curve slots being spaced from each other and each curve slot having multiple balls partially and rotatably accommodated therein;
two links each having a first end thereof connected to the protrusion of the operation assembly corresponding thereto, each of the rings including multiple spiral grooves formed to an inner periphery thereof, the spiral grooves being not in communication with each other, the multiple balls partially accommodated in the spiral grooves, the rings being axially movable relative to the operation assembly, and
two linings respectively connected to the two side parts of the caliper and located within the gap, when the rings move axially relative to the operation assembly and toward the gap, the two linings adapted to move and clamp a brake disk located between the two linings, wherein the two operation assemblies are rotated when the two links are respectively pivoted about the protrusions of the operation assemblies, the balls are rotated in the curve slots so that the rings are axially moved and protrude into the gap to move the two linings to be adapted to clamp the brake disk, when the two links are pivoted reversely, the two rings are moved into the threaded holes and the two linings adapted to remove from the brake disk.

2. The bicycle braking device as claimed in claim 1, wherein each of the operation assemblies includes a core part and a sleeve which is threadedly connected to the threaded hole of the link corresponding thereto, each sleeve has a mount hole defined axially therethrough, each of the core parts partially accommodated in the mount hole corresponding thereto, each core part has the protrusion protruding from one side thereof, and the protrusion protrudes beyond the sleeve, the protrusion of each core part has a toothed portion formed in an outer periphery thereof, the curve slots are formed to an outer periphery of each of the core parts, the toothed portion of each core part is engaged with the first end of the link corresponding thereto.

3. The bicycle braking device as claimed in claim 2, wherein a room is formed between an inner periphery of the sleeve and the outer periphery of the core part of each operation assembly, the ring is movably located in the room.

4. The bicycle braking device as claimed in claim 1, wherein the caliper includes two lugs between which the gap is located, a bolt extends through the two lugs and the two linings to position the two linings in the gap.

5. The bicycle braking device as claimed in claim 1, wherein one of the two links has a second end thereof connected to a brake cable which extends toward and is connected to another one of the two links so that the brake cable pivots the two links simultaneously.
